(19) United States
(12) Patent Application Publication
(10) Pub. No.: US 2022/0118684 A1
(43) Pub. Date: Apr. 21, 2022

(54) ADDITIVE MANUFACTURING PROCESS

(71) Applicants: Jason Glenn Miller, Houston, TX (US); Steven Colby Cupit, Houston, TX (US)

(72) Inventors: Jason Glenn Miller, Houston, TX (US); Steven Colby Cupit, Houston, TX (US)

(21) Appl. No.: 17/337,956

(22) Filed: Jun. 3, 2021

Related U.S. Application Data
(60) Provisional application No. 63/034,102, filed on Jun. 3, 2020.

(51) Int. Cl. B29C 64/118; B33Y 30/00; B33Y 10/00

(52) U.S. Cl. CPC B29C 64/118; B33Y 10/00; B33Y 30/00

(57) ABSTRACT

A system and method of additive manufacturing. A first layer having a first outer periphery is formed by extruding from a nozzle the material in a first spiral pattern extending from a starting point located on the first outer periphery toward a center of the first layer. When an inner limit is reached, a second layer having a second outer periphery is formed on the first layer by extruding the material from the nozzle in a second spiral pattern extending from the inner limit to the second outer periphery.

### CROSS-REFERENCE TO RELATED APPLICATION

This application claims priority to U.S. Provisional Application No. 63/034,102, filed Jun. 3, 2020, and entitled IMPROVED ADDITIVE MANUFACTURING PROCESS, the entirety of which is incorporated by reference herein.

### BACKGROUND

Additive manufacturing, sometimes referred to as 3-D printing, involves creating objects by extruding a material (e.g., plastic) in successive layers, one on top of the other. Additive manufacturing may also be referred to as “on-demand manufacturing” or “rapid manufacturing.”

An issue that arises in additive manufacturing are the voids in the material creating during the manufacturing process, thereby making the resulting object less dense. These voids are may be caused by, for example, sudden movements of the nozzle or the buildup of material, and may weaken the structure of the object.

What is needed is a method and system for additive manufacturing or 3D printing that results in decreased voids and increased density.

### BRIEF DESCRIPTION OF THE DRAWINGS

For a detailed description of various examples, reference will now be made to the accompanying drawings in which:

FIG. 1 shows an illustrative additive manufacturing system;

FIG. 2A shows an illustrative method for additive manufacturing;

FIG. 2B shows an illustrative layer formed by the method of FIG. 2A;

FIG. 3 shows an illustrative method for additive manufacturing;

FIG. 4 shows an illustrative layer formed by the method of FIG. 3;

FIG. 4A shows a portion of the illustrative layer of FIG. 4;

FIG. 4B shows a portion of the illustrative layer of FIG. 4;

FIG. 5 shows an illustrative layer formed by the method of FIG. 3; and

FIGS. 6-9 show an illustrative implementation of the method of FIG. 3.

### DETAILED DESCRIPTION

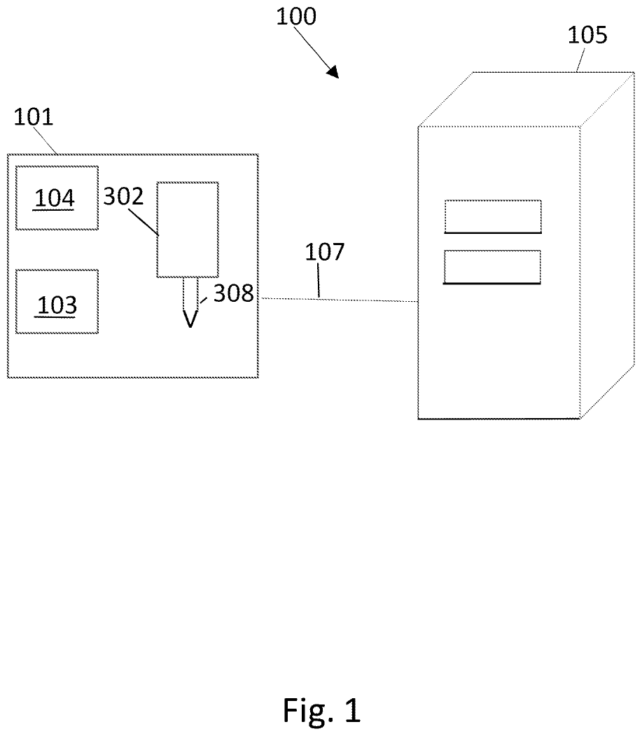

FIG. 1 shows an illustrative additive manufacturing or 3D printing system 100 according to examples described herein. 3D printing system 100 includes 3D printer 101, which may be, for example, a fused deposition modeling (FDM) printer or a fused filament fabrication (FFF) printer. 3D printer 101 has an extruder 102 with a nozzle 108. The extruder receives a solid material, softens the material with heat, and extrudes the softened material through nozzle 108. Nozzle 108 has a nozzle width, which represents the size of the opening in the nozzle 108 through which the heated and softened material is extruded.

3D printer 101 also has memory 103, which may store, for example, toolpath instructions. Memory 103 may comprise a non-transitory storage device such as volatile memory (e.g., random access memory). 3D printer 101 also includes processor 104 configured to execute the toolpath instructions and control the extruder 102. Computer 105 may be used to generate toolpath instructions using, for example, toolpath generation software executing on computer 105. Computer 105 may provide the generated toolpath instructions to 3D printer 101 via a network cable 107, or any other suitable means (e.g., other wired connections such as a universal serial bus (USB) cable or wireless connections such as Bluetooth or WiFi). The toolpath instructions may instruct the 3D printer 101 to form a series of layers. The toolpath instructions may provide instructions for creating each layer by, for example, defining an outer shape of the layer and an inner shape of the layer. The outer shape and inner shape may each be, for example, any line that is a closed loop and does not intersect itself. The outer shape and inner shape may be the same shape or they may be different shapes. For example, the outer shape may be a circle, while the inner shape defining the hollow space is a square. Either or both the outer and inner shapes may be irregular shapes. The outer shape and inner shape may be defined by, for example, an array of two-dimensional points.

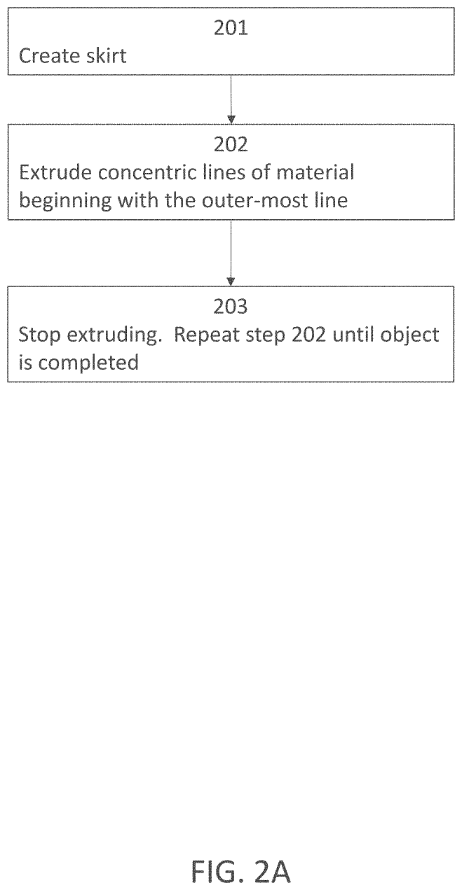

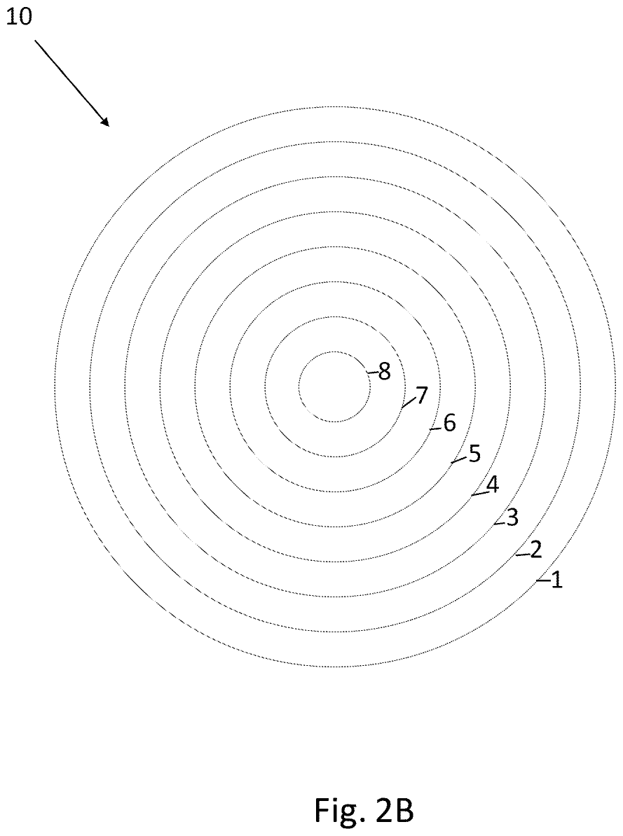

One method of creating objects using additive manufacturing is to create each layer as a series of concentric lines of extruded material, as illustrated in FIGS. 2A and 2B. FIG. 2A shows an illustrative method for creating the layer 10 in FIG. 2B. Each line 1-8 of FIG. 2B represents the line followed by the nozzle (e.g., nozzle 108) when the material is extruded. The nozzle may be aligned on each line such that the middle of the extruded material is aligned on each respective line.

At step 201, a skirt 1 may optionally be created. The skirt is one or more lines of extruded material added to the outer perimeter of the object for the purpose of, for example, increasing stability of the object during manufacturing. A skirt may be added to the first layer only, may be added to more than one of the bottom layers, and/or may be added to one or more other layers. The skirt may be removed after manufacturing, for example, by machining. FIG. 1 shows skirt 1 being one line of material, but the skirt may instead include more than one line of material. At step 202, concentric fines of material are extruded sequentially beginning with the outer-most line 2, which is adjacent to skirt 1, and ending with the inner-most line. In FIG. 1, the inner-most line is line 8. If the object is hollow, the inner-most line may be one of the other lines.

Each line of the skirt 1 may be of any width, and may be wider, narrower or the same width as each of lines 2-8. The width of each line of the skirt may be equal to the nozzle width. After creating each line 1-8, the extruder may stop extruding material, and the nozzle is moved toward the middle of the layer to a starting point on the next line to be printed. In some circumstances, this movement may be abrupt and may disrupt the material, for example by folding the material or rolling the material, which may create voids.

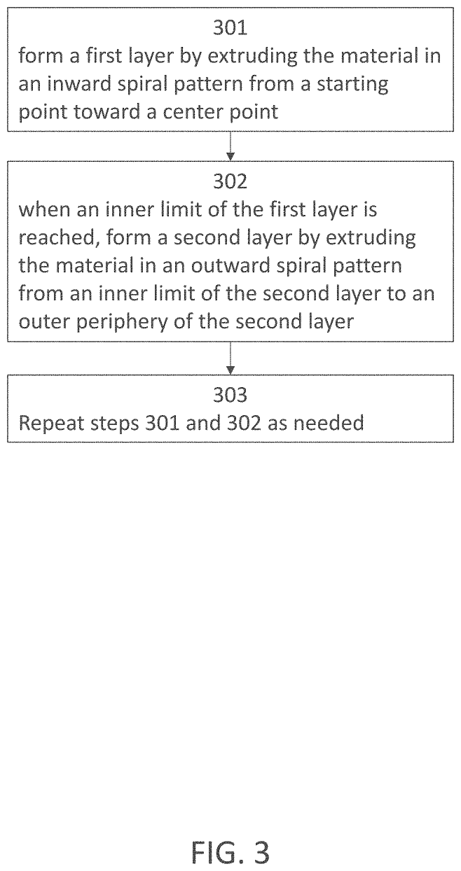

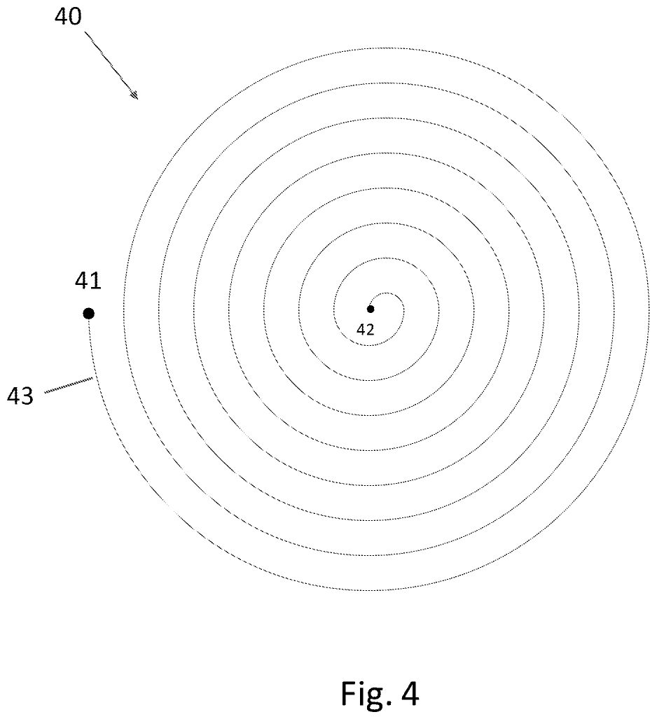

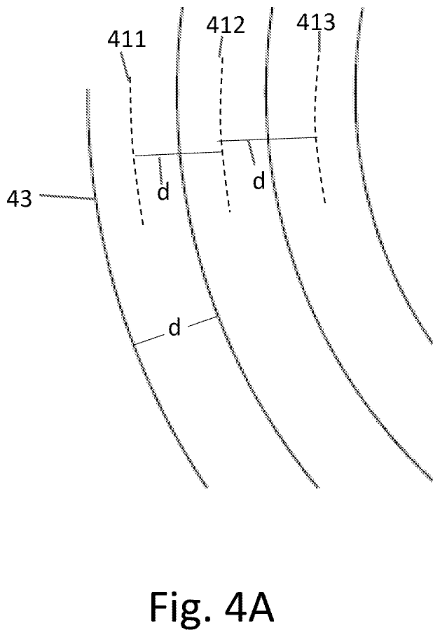

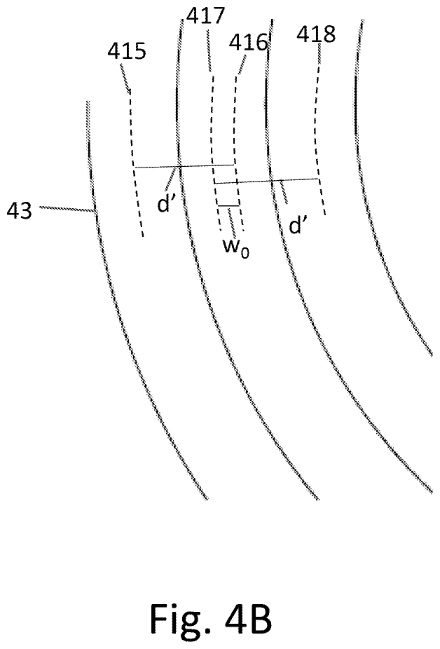

FIG. 3 shows another exemplary method of creating an object using additive manufacturing or 3D printing using a spiral-shaped pattern, and FIG. 4 shows an exemplary layer 40 created by the method of FIG. 3. The spiral pattern may be, for example, based on the Archimedes spiral pattern, which is generally represented by the following equation: r=a θ, where r is the distance from the center to a point on the spiral, a is a constant and θ is the angular position of the point on the spiral. The distance d between adjacent loops of line 43 is 2πa. The values of a and θ may be used to generate the toolpath instructions for generating each layer.

After performing any preliminary steps to prepare the 3D printer 101, at step 301 the 3D printer 101 forms a first layer by extruding the material in an inward spiral pattern from a starting point 41 toward a center point 42. Center point 42 may be, for example, the geometric midpoint or center of layer 40. The nozzle (e.g., nozzle 108) may be aligned on line 43 such that the middle of the extruded material is aligned on line 43. If distance d is equal to the nozzle width, each line of extruded material will generally abut each adjacent line with no space or overlap between, as shown in FIG. 4A. FIG. 4A shows a portion of layer 40 and the dimensions of two lines of extruded material where distance d is equal to the nozzle width. The first line of extruded material has a width of distance d that extends from line 411 to line 412. The second line of extruded material has a width of distance d that extends from line 412 to line 413. Because each of the first and second lines share line 412 as a boundary, the lines abut without overlapping and with no space in between.

When the distance d is less than the nozzle width, the lines of extruded material will generally overlap, as shown in FIG. 4B. In FIG. 4B, the first line of extruded material has a width of distance d′ that extends from line 415 to line 417. The second line of extruded material has a width of distance d′ that extends from line 416 to line 418. The two lines have an overlap of distance wₒ. Some overlap has several advantages. For example, overlap may build up on the nozzle and assist in pushing excess material in the direction of the nozzle, which is explained in more detail below. In addition, overlap may allow the heated nozzle and heated material coming from the nozzle to reheat portions of existing lines, which may enhance bonding between adjacent lines.

At step 302, when an inner limit of the first layer 40 is reached, a second layer is formed by extruding the material in an outward spiral pattern from an inner limit of the second layer to an outer periphery of the second layer. The outward spiral pattern of step 302 may be the same as the inward spiral pattern of step 301, except that the respective lines may not completely overlap due to slight variations in, for example, starting point and/or center point.

As the nozzle (e.g., nozzle 108) extruding the material moves from the starting point 41 to the center point 42 in step 301, excess material may build up on the nozzle and may be pushed by the nozzle toward the center point 42. By moving the nozzle (e.g., nozzle 108) back toward the outer periphery of the shape in an outward spiral pattern, the nozzle may push that excess material to the outside of the part where it can be removed (e.g., by machining) during or after manufacturing. The concentric circle process shown in FIGS. 1 and 2, however, may push any buildup of material to the center of the layer without reversing the pattern to push the material to the outside. This buildup of material in the center of the layer can result in voids that can weaken the resulting printed object.

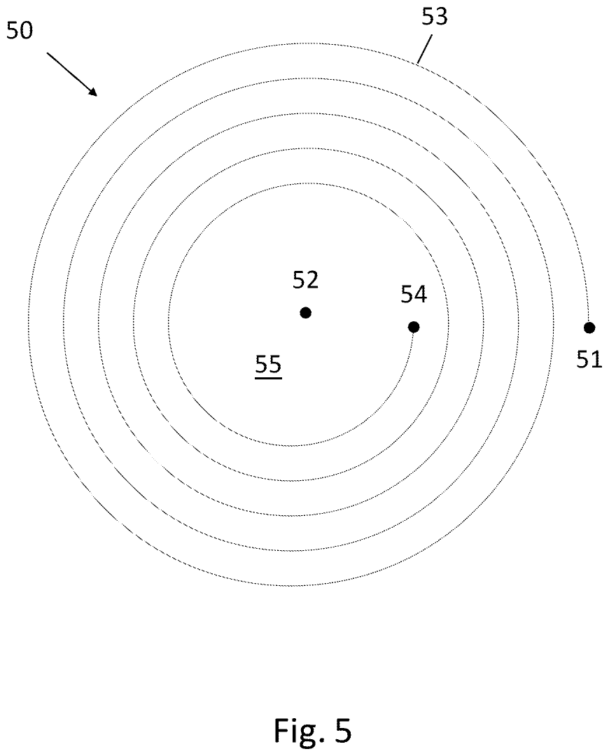

For layer 40 of FIG. 4, the inner limit of line 43 is center point 42 because layer 40 is not hollow. For a hollow object, the inner limit may not be the center point of the layer. For example, layer 50 of FIG. 5 is identical to layer 40 of FIG. 4 except that layer 50 has a different inner limit such that the nozzle does not continue extruding along line 53 all the way to center point 52, but instead stops at inner limit 54 creating open portion 55. At step 303, steps 301 and 302 are repeated to provide as many layers as necessary for the object. While the layers 40 and 50 of FIGS. 4 and 5 show a counter-clockwise spiral pattern, the pattern may instead be clockwise.

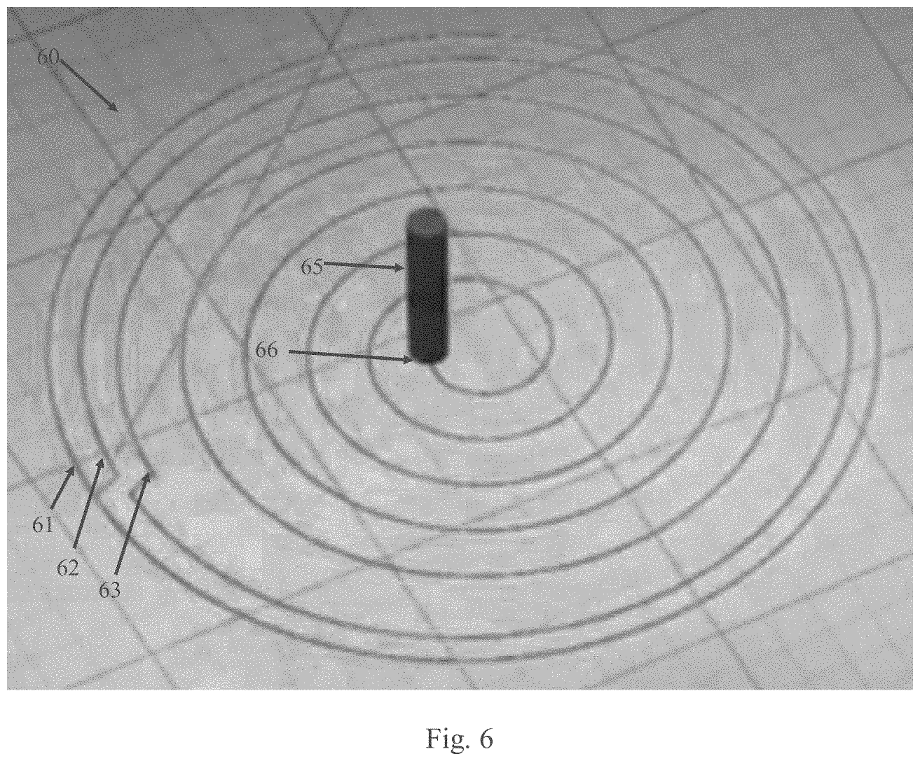

A skirt may be added to an object created using the process described in FIGS. 3 and 4. FIG. 6 shows an example implementation of a first layer 60 generated by step 301 that includes a skirt. In the example in FIG. 6, a skirt comprised of two rotations 61 and 62 is formed before the inward spiral pattern begins at or near point 63. The skirt may instead be more or less than two rotations 6, and the distance d may be greater or lesser than that shown in FIG. 6

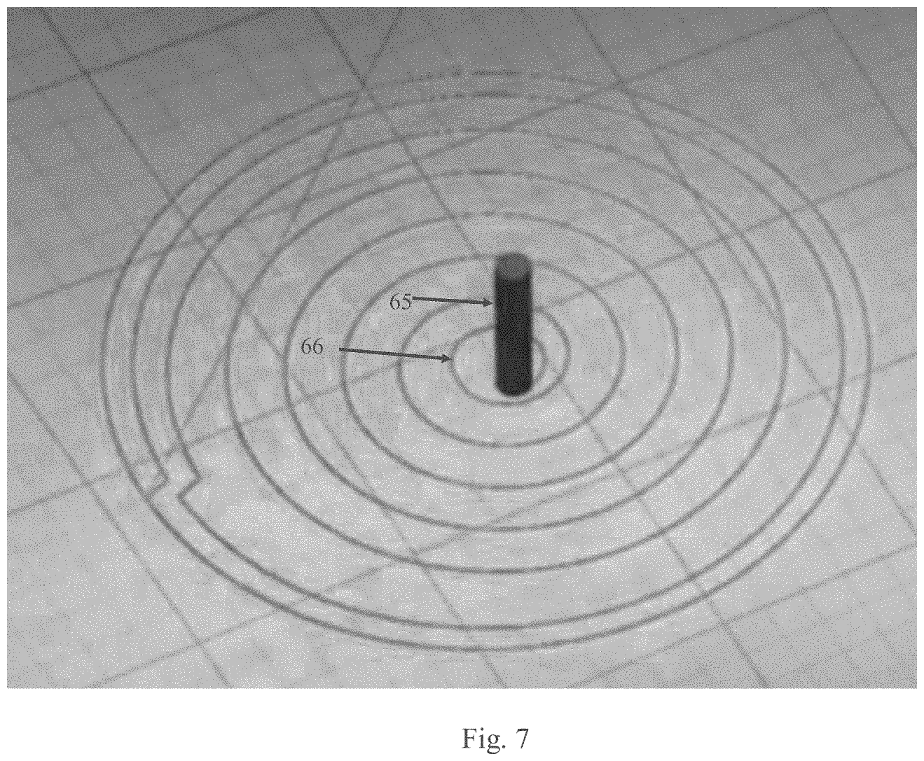

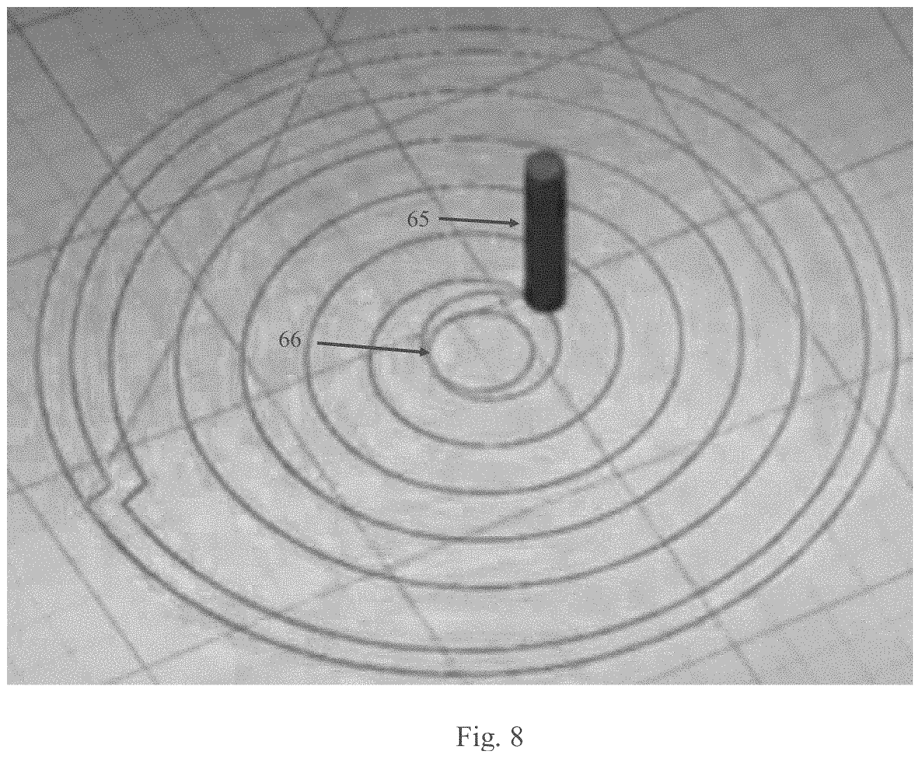

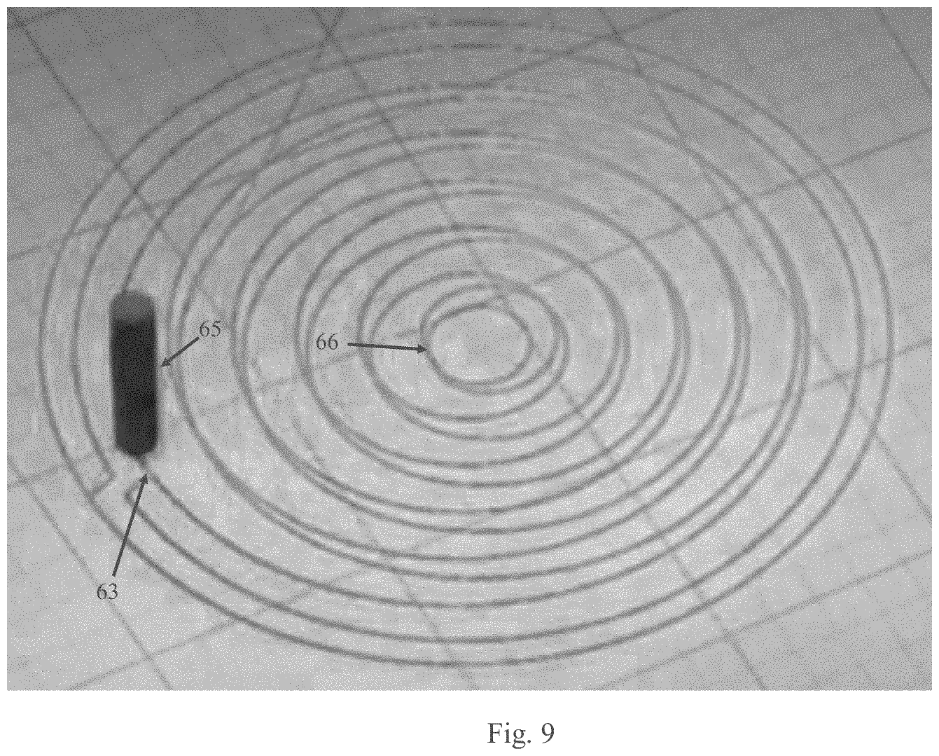

FIG. 6 shows layer 60 at about the point where extruder 65 reaches the center point 66 and will begin the outward spiral pattern second layer of step 302. FIG. 7 shows a point in time just after step 302 begins and extruder 65 begins its outward spiral pattern. FIG. 8 shows a point in time during step 302 that is after the point in time in FIG. 7. FIG. 9 shows the extruder 65 after it has completed the second layer in step 302 and is begins to perform step 303 by repeating step 301 to form a third layer with a starting point at or near point 63. While FIGS. 6-9 show clockwise spiral patterns, the patterns may instead by counter-clockwise.

While the examples described above have outer shapes and, where appropriate, inner shapes, that are circular, as described above the outer shapes and inner shapes are not so limited and may be any line that is a closed loop and does not intersect itself. The inner shape and outer shape need not be the same shape, and may instead be different shapes. The material used in the processes described herein may be, for example, PEEK, polymers, including thermosetting polymers, and plastics. The material may be, for example, pellet or filament heads.

Modifications are possible in the described embodiments, and other embodiments are possible, within the scope of the claims.

What is claimed is:

1. A method of manufacturing an object, the method comprising:
a. forming a first layer having a first outer periphery by extruding from a nozzle the material in a first spiral pattern from a starting point located on the first outer periphery toward a center of the first layer; and
b. when an inner limit is reached, forming on the first layer a second layer having a second outer periphery by extruding from the nozzle the material in a second spiral pattern from the inner limit to the second outer periphery.

2. The method of claim 1, wherein the inner limit is equal to a midpoint of the first layer.

3. The method of claim 1, wherein the inner limit is not equal to a midpoint of the first layer.

4. The method of claim 1, wherein the first layer has a hollow inner portion defined by the first limit.

5. The method of claim 4, wherein the first layer has an outer shape that is circular, and the hollow inner portion has a shape that is circular.

6. The method of claim 4, wherein the first layer has an outer shape that is square, and the hollow inner portion has a shape that is circular.

7. The method of claim 1, further comprising forming a skirt around the first layer.

8. The method of claim 1, wherein at least one of the first and second spiral patterns have a distance between successive lines of the respective spiral pattern that is less than a width of the nozzle.

9. The method of claim 1, wherein at least one of the first and second spiral patterns have a distance between successive lines of the respective spiral pattern that is equal to a width of the nozzle.

10. The method of claim 1, further comprising repeating steps a and b until the object is completed.

11. A method of operating a three-dimensional (3D) printer, the method comprising:
forming a first layer having a first outer periphery by extruding the material in a first spiral pattern from a starting point located on the first outer periphery toward a center of the first layer; and
when an inner limit is reached, forming on the first layer a second layer having a second outer periphery by extruding the material in a second spiral pattern from the inner limit to the second outer periphery.

13. A system for additive manufacturing, the system comprising:
means for forming a first layer having a first outer periphery by extruding the material in a first spiral pattern from a starting point located on the first outer periphery toward a center of the first layer; and
means for forming on the first layer, when an inner limit is reached in the first layer, a second layer having a second outer periphery by extruding the material in a second spiral pattern from the inner limit to the second outer periphery.

14. The system of claim 13, further comprising a means for creating instructions for forming the first layer and second layer, and a means for providing the instructions to the forming means.
